(19) United States
(12) Patent Application Publication
(10) Pub. No.: US 2008/0173627 A1
(43) Pub. Date: Jul. 24, 2008

(54) Configurable padding for pets

(75) Inventors: Amy Martin, Seattle, WA (US); Russell Borgmann, Bellevue, WA (US); Paul Vincent, Snoqualmie, WA (US); Michael Deilke, Langley, WA (US); Alison Deilke, Langley, WA (US); Richard Fine, Mercer Island, WA (US)

Correspondence Address: PERKINS COIE LLP;PATENT-SEA, P.O. BOX 1247, SEATTLE, WA, 98111-1247, US

(73) Assignee: Hyperion Innovations, Inc., Bellevue, WA (US)

(21) Appl. No.: 11/654,574

(22) Filed: Jan. 18, 2007

(51) Int. Cl. A01K 1/035; H05B 1/00

(52) U.S. Cl. 219/201; 119/28.5

(57) ABSTRACT

A pet pad that can be configured to fit in a variety of different vehicle cargo spaces. The pet pad has a main portion and a plurality of extending portions coupled to the main portion. The extending portions have a first position in which they are drawn into the main portion and a second position in which the extending portions increase a surface area of the pet pad. The pet pad can include a heating and/or cooling device.

### TECHNICAL FIELD

The following relates to padding, and more particularly, portable pet pads for use in automobiles or other confined spaces.

### BACKGROUND

Portable pads are commonly used with domesticated pets. For example, small, cushion-like pads are often used to provide a comfortable (e.g., cushioned) place to rest or sleep, for pets such as cats and dogs, whether on the floor, a window sill, or at another location. Typically, pet cushions are used to provide cushioning for a pet lying on a hard (sometimes cold) floor in a room of a home.

It is also known to provide a pet crate, cage, or other type of containment mechanism in a vehicle to contain an animal in an automobile while in transit. In sport utility vehicles (“SUVs”), station wagons, hatchbacks, or mini-vans, fencing may be provided to contain the animal in the cargo space behind the passenger seating area in the vehicle. This is particularly useful for when small children are seated in the second row passenger compartment so as to prevent the animal from leaping over the back of the seat and possibly harming the children or the animal itself.

When an animal is contained in the rear cargo space of a vehicle, the pet typically stands, sits, or rests directly on the carpeting installed in the cargo space. Since the cargo space may be used for other purposes, this flooring may be dirty and unsanitary for the pet. Conversely, the pet may cause the carpeting to become dirty, soiled, covered with pet hair and dander, or otherwise undesirable. Furthermore, during winter months, the cargo space may become cold. Since the cargo space is not intended for passengers, it would be atypical to include heating vents to warm the area. As a result, pets traveling in the rear of a vehicle such as an SUV, station wagon, hatchback, or mini-van can become cold and uncomfortable while in transit.

Accordingly, it is desirable to provide improved portable pet padding for pets.

### SUMMARY

Portable pet pads are disclosed that are easily re-configurable and transportable, and are provided with cushion material to compensate for harsh (e.g., hard) resting or sleeping conditions that would otherwise be faced by a pet. While the pet pads can be used anywhere electricity is or is not available, indoors or outdoors, it is contemplated that the pet pad can be used in the cargo space of a vehicle, such as an SUV, station wagon, hatchback, or mini-van. The extending portions of the pet pad can be extended to expand the surface area of the pad, to cover a greater portion of the cargo space, depending upon its surface area.

### BRIEF DESCRIPTION OF THE DRAWINGS

Additional embodiments will be more apparent upon consideration of the following detailed description, taken in conjunction with the accompanying drawings, in which like reference characters refer to like parts throughout, and in which:

FIG. 1A is a perspective view of the pet pad of FIG. 1A in a folded position.

FIG. 1B is a perspective view of a pet pad according to an exemplary embodiment in an open position;

FIG. 1C is an isometric view of the pet pad of FIG. 1A in an open position showing the control panel and plate.

FIG. 1D is a side view of a cutaway portion of the pet pad of FIG. 1A in an unsecured position;

FIG. 1E is a side view of a cutaway portion of the pet pad of FIG. 1A in a secured position;

FIG. 2 is an illustration of heat transfer channels in a cushion of the pet pad according to an exemplary embodiment;

FIG. 3 is an illustration of a single heat transfer channel in a cushion of the pet pad according to an exemplary embodiment;

FIG. 4 is a side view of a heating or cooling device enclosed in plastic with heat transfer channels according to an exemplary embodiment;

FIG. 5A is a simplified illustration of a circuitous path for heat transfer tubing in a cushion of a pet pad in accordance with an exemplary embodiment;

FIG. 5B is a simplified illustration of a path for heat transfer tubing in a cushion of a pet pad in accordance with an exemplary embodiment;

FIG. 6 is an illustration of a control panel.

FIG. 7A is a simplified illustration of a control panel mounted on a pet pad according to an exemplary embodiment;

FIG. 7B is a simplified illustration of a power cable to connect to a battery pack in a pet pad according to an exemplary embodiment;

FIG. 7C is a simplified illustration of a power cable to connect to either a battery pack or a standard outlet according to an exemplary embodiment;

FIG. 7D is a simplified illustration of a removable pet pad cushion with a battery pouch according to an exemplary embodiment;

FIG. 7E is a simplified illustration of an opening to insert and remove a battery pack for a pet pad according to an exemplary embodiment.

FIG. 8A is an isometric view of a pet pad according to an exemplary embodiment in an open position;

FIG. 8B is an isometric view of the pet pad of FIG. 8A in a folded position.

FIG. 9A illustrates an isometric view of a pet pad according to an exemplary embodiment in a rolled up position.

FIG. 9B is an isometric view of the pet pad of FIG. 9A in an unrolled position.

FIG. 9C is a side view of a cutaway portion of the pet pad of 9B.

FIG. 9D is a side view of a cutaway portion of an exemplary embodiment of the pet pad in an unrolled position.

FIG. 9E is a side view of a cutaway portion of the pet pad of FIG. 9A in the rolled up position.

### DETAILED DESCRIPTION

The following describes configurable heating and/or cooling pads for pets, and methods and systems for using the same. The details included herein are for the purpose of illustration only and should not be understood to limit the scope of the disclosure. Moreover, certain features that are well known in the art are not described in detail in order to avoid complication of the subject matter described herein.

A portable heating and/or cooling pad is disclosed that includes at least one temperature regulation element for altering the temperature of the pad. The pad is configurable to fit a variety of spaces.

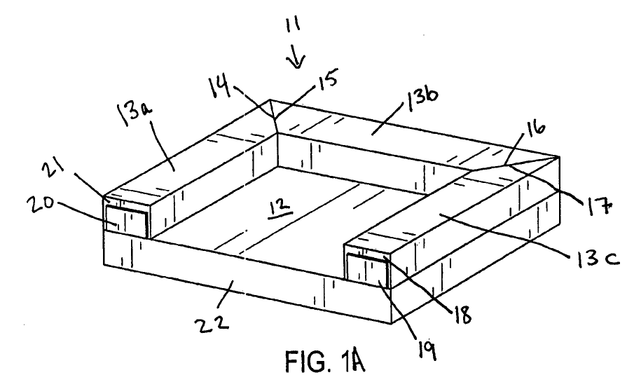

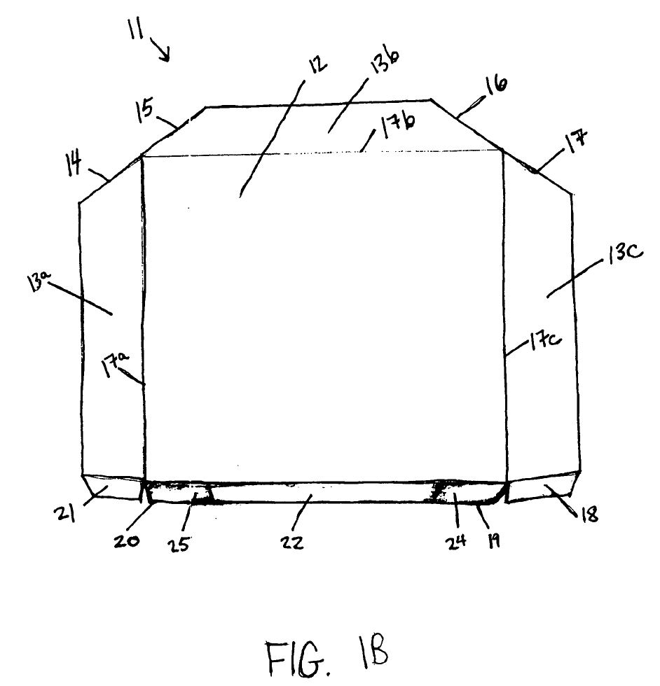

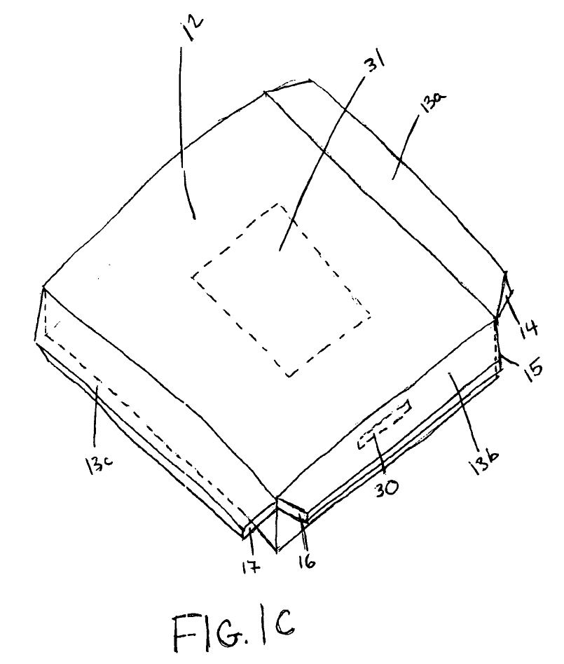

FIG. 1A provides a perspective view of an exemplary embodiment of a portable pet pad in the folded position. FIG. 1B provides a perspective view of portable pet pad of FIG. 1A in the open position. In the folded position, extending portions 13a and 13b provide a uniform wall of support and/or cushioning. It is understood that the invention is not limited to the particular location or placement shown of or discussed for any element. As shown in FIG. 1B, pet pad includes a main portion 12, which acts as a primary seating surface. Three extending portions 13a, 13b, and 13c are each attached to a side of main portion 12 by a living hinge 17a, 17b, and 17c, which enables each extending portion 13a, 13b, and 13c to be folded on top of main portion 12, as shown in FIG. 1A. Although a living hinge is exemplified, any type of hinge is sufficient. The shape of extending portions 13a, 13b, and 13c is such that they may lay flat on top of the main portion 12 without overlapping. Also, the shape of each extending portion 13a, 13b, and 13c is such that the pet pad appears to be ready for use in either the open or folded position. In other words, the pad looks like it is meant to be used in either position.

Two surfaces 14, 21 of extending portion 13a are covered by either hook or loop fasteners, e.g. VELCRO. Surfaces 15,16 of extending portion 13b and surfaces 17, 18 of extending portion 13c are also covered by either hook or loop fasteners. When extending portions 13a and 13b are folded on top of main portion 12, surfaces 14, 15 are adjacent one another. Since surface 14 is covered by loop fasteners, when surface 15 is covered by hook fasteners, and vice versa, their hook and loop fasteners will mate upon contact. Once extending portions 13a and 13b are folded, the user may push surfaces 14, 15 together to ensure that they their hook and loop fasteners connect securely. The hook and loop fasteners facilitate holding extending portions 13a and 13b together in the folded position. The relationship between surfaces 16, 17 is the same as the relationship between surfaces 14, 15. When extending portions 13b, 13c are folded on top of main portion 12, surfaces 16, 17 are adjacent one another and their hook and loop fasteners connect. In an alternative embodiment, the hook and loop fasteners may be replaced by any other type of fastener, including but not limited to snaps, magnets, or latches.

Two flaps 19, 20 extend from the front surface 15 of main portion 12 in a hanging manner, as shown in FIG. 1B. FIGS. 1D and 1E provide a detailed side view of flap 19 (flap 20 is identical to flap 19). Each of flaps 19, 20 has a surface 24, 25 covered by hook or loop fasteners. When surface 21 is covered by loop fasteners, surface 25 is covered by in hook fasteners, and vice versa. The same relationship exists between surfaces 18, 24. When extending portions 13a, 13c are folded on top of main portion 12, as shown in FIG. 1A, the user can lift flaps 19, 20 up so that the hook or loop fasteners of flap surfaces 24, 25 mate with the hook or loop fasteners of surfaces 18, 21, as shown in FIG. 1E. When attached to surfaces 18, 21 the flaps 19, 20 further secure extending portions 13a, 13c in the folded position. In an alternative embodiment, the hook and loop fasteners may be replaced by any other type of fastener, including but not limited to snaps, magnets, buckles, ties, or latches. Although the folded position discussed above includes each of extending portions 13a and 13b being folded, it is contemplated that only one or two of extending portions 1 3a and 1 3b may be folded at a time.

Pet pad, including main portion and extending portions, may be made from or include any suitable material. According to various embodiments, these may be made from and/or include foam and/or ballistic nylon. Such materials and those similar that are known in the art, may be used when the ambient air temperature is relatively high (e.g., during the summer time). Alternatively, for example, pet pad may be made from and/or include fleece, imitation sheep skin, or suede material. Such material may be used, for example, when the ambient air temperature is relatively low (e.g., in the winter time). Thus, different materials may be used in order to enhance the comfort level of a pet using pet pad (e.g., when external temperature changes make different types of surfaces desirable to the pet, or when a different pet that prefers a different type of material is to use pet pad).

Although not shown, pet pad may also include cushion material (e.g., made from polyurethane foam or elastomer foam) or other suitable material for enhancing the comfort experience of a pet. For example, cushion material and/or other suitable material may be located below and/or the one or more heating and/or cooling elements located in pet pad. Alternatively, the one or more elements may be positioned within, but near the upper surface of, the cushion material. It is noted that the one or more heating and/or cooling elements may be separately controlled. It is also noted that placement of cushion material or other suitable material above the one or more heating elements may, in addition to making pet pad more comfortable, serve to reduce the transfer of heat from pet pad to the object on which pet pad is situated during operation. In one embodiment, the cushion material is made of orthopedic foam, of a consistency designed to protect joints and provide appropriate support to the skeletal system of a domesticated animal and facilitate a comfortable experience for a pet resting on the pad. Moreover, when pet pad includes cushion material, according to various embodiments, the cushion material may be removable. In other embodiments, instead of foam, the pet pad may include a soft, pliable, and re-maneuverable stuffing material to provide cushioning. Such cushioning material may include synthetic pillow stuffing such as polyester filling, or may include feathers such as goose or duck down. As a further alternative, the pet pad may include a combination of dense foam and softer pillow stuffing. It is contemplated that different types of cushioning may be utilized for different types of animals.

FIG. 1C provides an isometric view of the portable pet pad 11 in the open position from the side opposite the side shown in FIG. 1B. Control panel 30 slides into main portion 12, shown in FIG. 1C. The control panel of further embodiments may be inserted into the main portion in the same manner. Main portion 12 may draw low current, and may use any suitable type of power source (or a combination of more than one type of power source). For example, power may be provided to the one or more heating elements of main portion 12 by a portable power device, such as a battery pack that includes Alkaline batteries (such as “D” sized batteries), one or more Lithium-Ion batteries, one or more nickel-metal-hydride batteries, and/or one or more other types of batteries.

According to various embodiments, the battery pack being used for providing power to the one or more heating or cooling elements may be rechargeable or replaceable with a new battery pack. For example, when the battery pack is partially or completely discharged (drained of power), the battery pack may be recharged by removing it from the pet pad and placing it in a stand alone charging device that charges the battery pack using power from, e.g., an AC power outlet. In this case, a different, pre-charged battery pack may be connected to (and used to provide power to) circuitry of pet pad while the original battery pack is charging, thereby substantially reducing the amount of time that pet pad will go without power when the original battery pack is discharged. It is noted that, when a removable battery pack is used in connection with pet pad, this battery pack will be electrically connected to control panel. As described below in further detail, the battery pack can be disconnected from the control panel when it is removed from pet pad for recharging. Alternatively, the battery pack may be attached to the control panel in a manner such that the control panel is removed as well with the battery pack. The disclosure is not, however, limited in this manner.

It is noted that, a pad cover (not shown) may be used, and it may serve to additionally protect the control panel and/or a power source, even when one or both are situated in an external manner. When a pad cover is used, according to various embodiments, it may be made from vinyl or another suitable material that is able to withstand low and high temperatures, rain, moisture, and the like. Such a pad cover may also include one or more logos (e.g., advertisements) on the surface of the pad cover. It is also contemplated that the exterior of the control panel and/or a power source may be rigid and environmentally robust, such that either or both of these elements remain adequately protected even when the optional cover is not designed to cover these elements. Additionally, according to various embodiments, any cover that is being used may be removable (e.g., using a zipper or buttons), and may be machine or hand washable. Moreover, the bottom of such a cover (or main portion itself) may include a nonslip surface formed by gripping elements (not shown) that may be used to prevent sliding when pet pad is being used, e.g., on a slippery surface.

When a pad cover is used with the embodiment of FIGS. 1A, 1B, and 1C, the cover (not shown) can include cut-outs for the fasteners to be attachable to each other when pet pad 11 is in the folded position. Alternatively, the cover can include the fasteners necessary for extending portions 13a, 13b, and 13c to be secured in the folded position. Also, the cover must be appropriately proportioned for extending portions 13a, 13b, and 13c to be capable of folding.

As shown in FIG. 1C, according to various embodiments, main portion 12 may house a plate 31. Plate 31 can provide heating and/or cooling of the pet pad 11 through thermoelectric principles, i.e., as a Peltier cooler or heater. In some embodiments, plate 31 functions only as a cooling device.

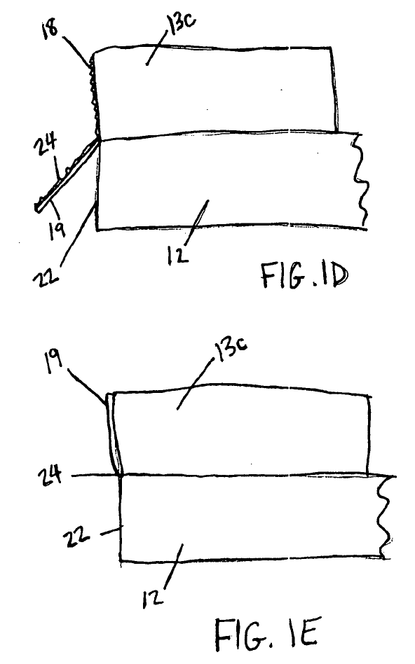

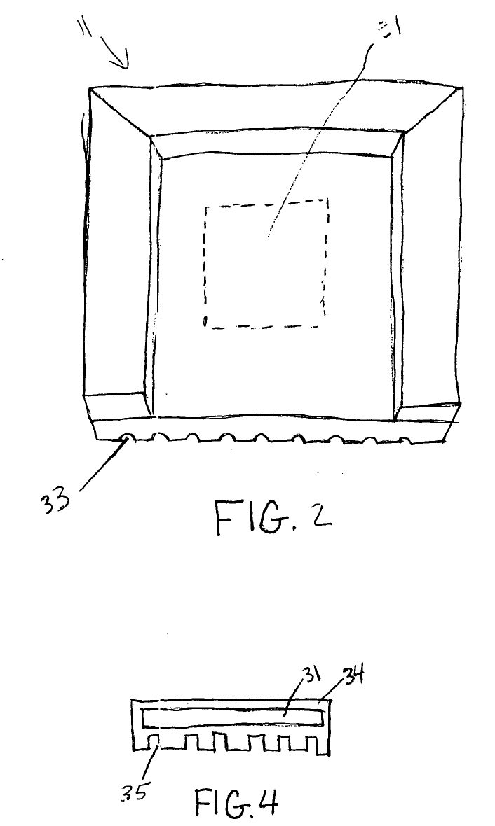

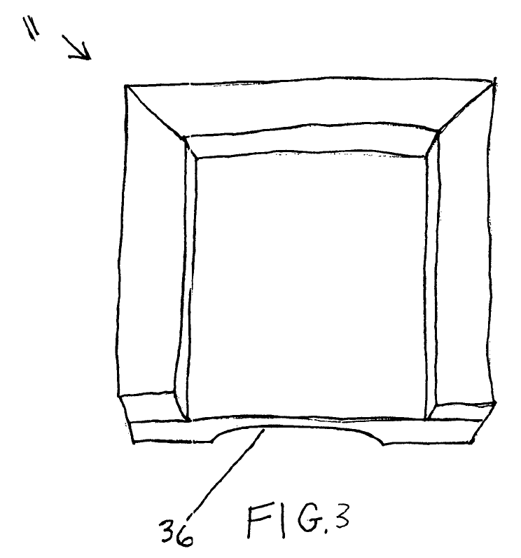

As shown in FIG. 2, heat transfer grooves 33 are provided in main portion 12 to dissipate heat when plate 31 is functioning as a cooler. Alternatively, heat transfer grooves 33 disperse cold when plate 31 is functioning as a heater. As shown in FIG. 4, plate 22 may be encased in plastic 31 or some other suitable material known in the art. Plastic 34 can be designed with heat transfer grooves 35 to work in conjunction with heat transfer grooves 33 in main portion 12 through the use of cooling fins that may be part of plastic 34 or part of plate 31. In alternate embodiments, plate 31 may be multiple plates or may be divided into thermal sections that can be operated independently. In other embodiments suggested by FIG. 3, heat transfer groove 36 is a single large groove. Additionally, the energy transfer function of groove 33 or groove 36 may be improved through use of a fan.

In alternative embodiments, main portion 12 houses a heater element (not shown). The heater element may be Nichrome wire, a mix of carbon and silver paste, or a semiconductive material, such as a flexible carbon material or a flexible graphite material such as graphite foil, fabric, or felt. Those skilled in the art will recognize various means of generating heat through the application of voltage to suitable materials.

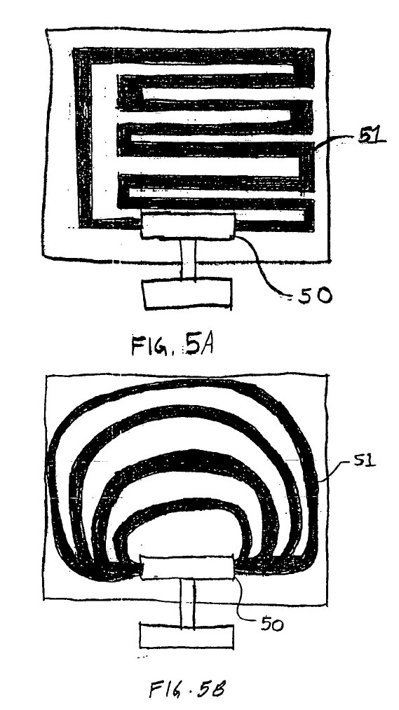

In other embodiments, as illustrated in FIGS. 5A and 5B, shown according to various embodiments, a heating or cooling device 50 includes a fan (not shown) and contiguous tubing or a cut-out/etching within the padding to form a channel 51. Air is re-circulated through channel 51 to maintain a cool or warm temperature. The cut-out portions within the padding may be supported by netting or a net covering so as to facilitate the return to the original shape of the channel after being compressed by an animal resting upon it. The process of etching or channeling the circuitous path may be performed by dividing the padding into several layers, each with a netting cover. Integration of a conditioner into the pattern is also a feature.

As shown in FIG. 6, shown according to various embodiments, control panel 53 may include an indicator light 58, a selector switch 57, a power switch 56, an electrical connection 55, or combinations thereof. Indicator light 58 may be an LED. Additionally, additional indicator lights may be included to serve other functions, for example, provide visual indication of the operating power level of the unit. Selector switch 57 may be used to change the pad from heating to cooling mode (or vise versa) or select an appropriate power source (e.g., first battery, second battery, 120 V AC, car adapter). The disclosure is not limited by the types of power sources being used, or by the number of power sources being used. For example, when three power sources are being chosen from, selector switch 57 would establish a connection between one of the three power sources, or when the heating function is to be OFF, none of these power sources. Other configurations achieving the same result known in the art may also be used, such as multiple push-buttons or a selector slide. In alternate embodiments, a dial (not shown) may allow a pet owner to select a desired temperature for her animal and the pet pad will automatically attempt to regulate the temperature of the pad to match. For example, multiple temperature sensors are used to measure the temperature throughout the pad. A controller may use the data from these temperature sensors to adjust the temperature of the pet pad, for example through use of actuation at a set-point or a control function to ramp to the desired temperature. Moreover, an additional temperature sensor may be provided to measure the temperature of ambient air such that the temperature of the pad may be substantially maintained a pre-determined difference from ambient. Electrical connection 55 may allow the temperature regulation features of the pet pad to function on standard 120 V AC, or a vehicle power source (e.g., 12 V DC) in lieu of an internal power source. In some embodiments, while operating on an alternate power source, an internal power source, e.g. a battery pack, within the pet pad is being recharged.

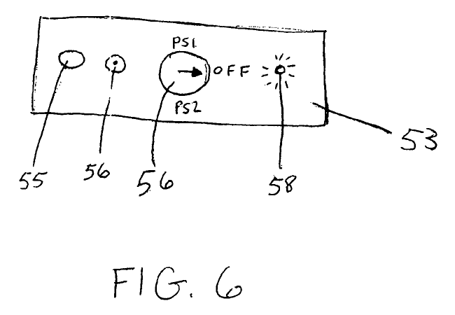

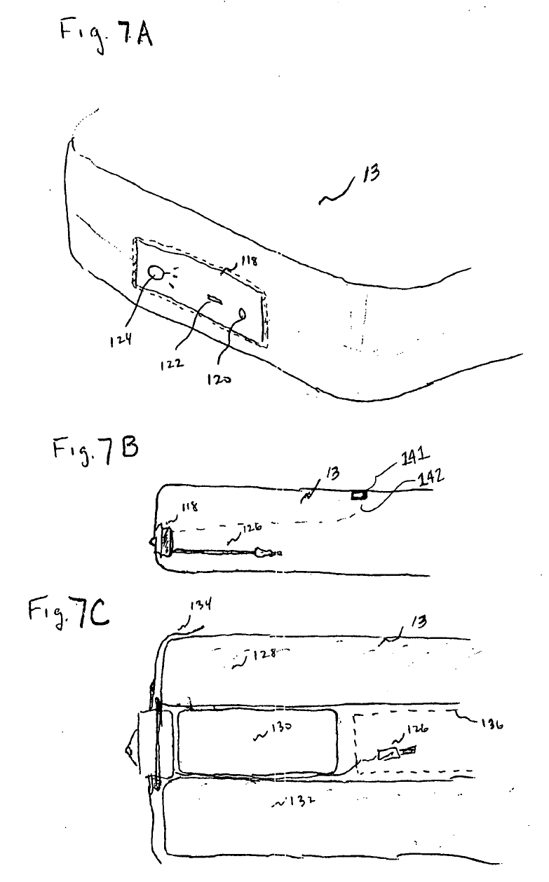

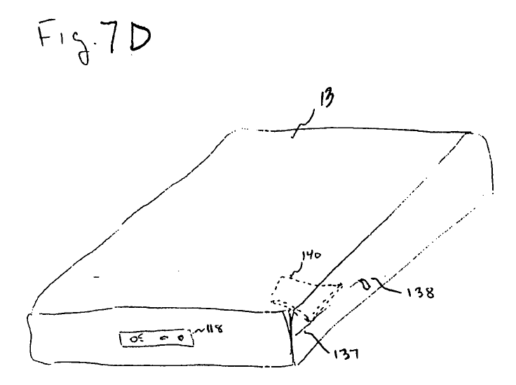

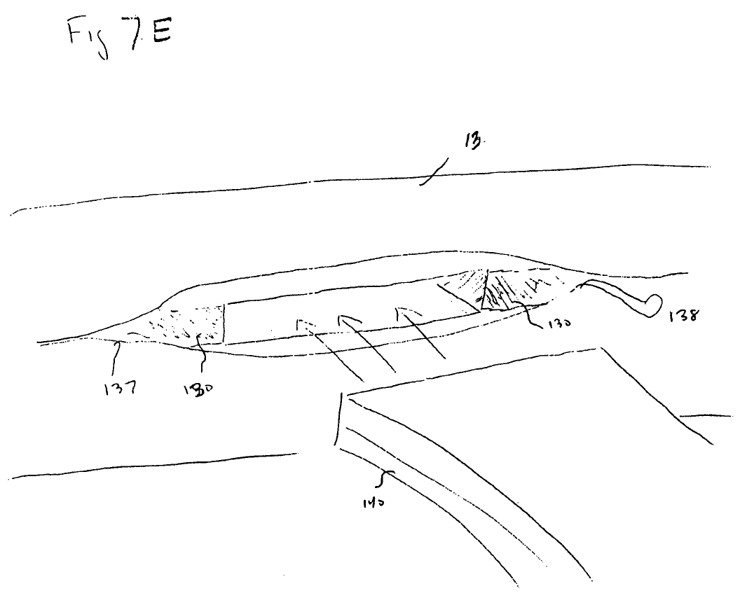

FIG. 7A illustrates, shown according to various embodiments, an alternate arrangement for a control panel 118 with a three position switch 124 for selecting heating mode, cooling mode, and off; a power switch 122; and an external electrical connection port 120. FIG. 7B illustrates an exemplary means of connecting a battery inside main portion 12 to a control panel 118 with a cord 126. FIG. 7C provides a more detailed cross-sectional illustration of the pad. In the pad, beneath fabric 134, a first foam 128 is provided for the upper portion of the pad. A second foam 130 may be provided beneath a portion of the first foam 128. This second foam 130 surrounds the battery, which is placed in a section 136 defined by the bottom of the first foam, the front of the second foam, and the top of a third foam 132. In some embodiments, the power source or control panel may be removed without disturbing the other component. When an external power source, e.g., an AC power outlet in a home, is used to provide power to main portion 12, for example, this power source may be connected to the main portion 12 using connection 65. The power from the power outlet can be converted using an AC/DC converter (not shown). When an AC/DC converter is being used, it may be included with (part of) the circuitry of the pet pad or may be included with the AC power plug. The disclosure is not limited in this manner that connects the AC outlet to connection port 65. When the heated pad is being powered by an AC power outlet, it can be appreciated that by configuring the pad to draw low current, a low voltage will be provided across the power cord, which will reduce harm should a pet chew through the power cord.

In alternative embodiments, additional features may be added to the pet pad that may work in conjunction with control panel 63. For example, a sensor 141 may be included that will determine if the pad is in use or about to be used and cause the control panel, connected by wire 142, to begin heating or cooling the pet pad as selected by switch 67. Examples of sensors include but are not limited to one or more motion sensors or infrared sensors, which could detect an animal before it has even entered the pet pad allowing the pad to be more comfortable when the animal actually arrives because of the early start; one or more pressure sensors, which would register the weight of an animal on part of the pad; one or more thermal sensors, which could both indicate the presence of an animal and be used to regulate the temperature of the pet pad; one or more vibration sensors to detect entry by an animal; one or more angular (e.g., non-horizontal) positioning sensors through any suitable means of detection, including, for example, a level detector or a gyroscope, which may be used to detect when the pad is being transported and de-energize and heating or cooling elements; and combinations thereof. Multiple sensors could be used in parallel such that a pet is more likely to activate at least one when using the pet bad. Alternatively multiple sensors could be used in series to reduce the likelihood that the pad is accidentally activated.

In some embodiments, indicator 68 will notify an owner when a battery needs to be recharged or replaced. Instead of or in addition to indicator 68, an audible indication may also be provided.

Additional embodiments may also include other features for safety purposes such as fuses or flame retardant materials in the construction of the pet pad. A fuse circuit may be any suitable type of fuse circuit that is capable of providing over current protection. For example, a fuse may be designed to melt and open the circuit under abnormally high electric loads. Alternatively, according to various preferred embodiments, a fuse will operate to only temporarily open a circuit. In this manner, the triggering of fuse circuit may not require servicing of the pet pad.

According to FIGS. 7C-7E (shown without extending portions 13a, 13b, and 13c), a battery 140 may be stored inside main portion 12 by means of a pouch 137. Pouch 137 may have a recloseable entry mechanism 138 such as a zipper, VELCRO, or buttons. Spacing foam 130 may be included to ensure battery 140 remains stable and does not become disconnected when the pad in used by an animal. Additionally or alternatively, additional pouches may be added or pouch 137 may be used to pet treats or toys. In at least one embodiment, the pouch can be sealingly opened and closed, such as with a “Ziploc” type seal, so that the pet cannot discern pet treats stored therein. In another embodiment, the pouch may include openings so that the pet can smell a scent emitted from items stored therein. This can be particularly advantageous if a per owner wishes to insert a plant material or other chemical to induce the pet to sleep or otherwise become sedated.

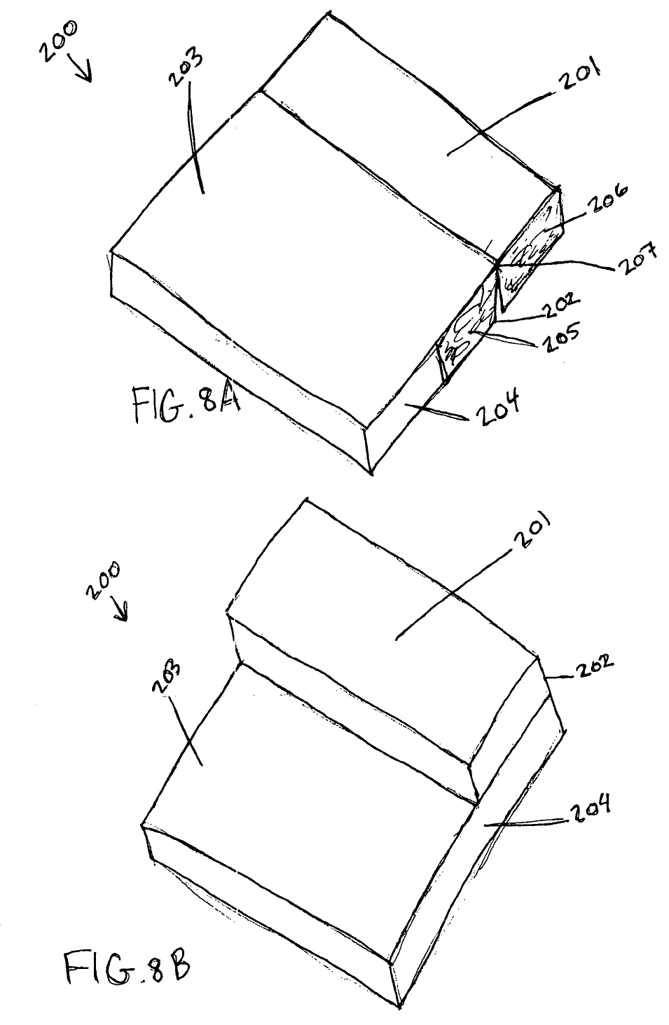

An alternative to the folding configuration of FIG. 1 is illustrated by the pet pad 200 in FIG. 8A. In this embodiment, only one extending portion 201 is connected to a main portion 203 by a living hinge 207, as shown in FIG. 8A. Although a living hinge is exemplified, any type of hinge is sufficient. Extending portion 201 flips on top of main portion 203, as shown in FIG. 8B. This embodiment is particularly useful when a change in only one dimension is required. Also, this embodiment may be used to provide the pet with a large pillow in the form of extending portion 201.

Extending portion 201 may be large and rectangular in shape, since there is no complication of other extending portions overlapping with it. A flap 202 is located on a side 204. A surface 205 of flap 202 is covered by either hook or loop fasteners. When surface 205 is covered by loop fasteners, surface 206 of extending portion 201 is covered by hook fasteners, and vice versa. Upon folding extending portion 201 on top of main portion 203, the user may lift flap 205 so that its hook or loop fasteners mate with the hook or loop fasteners of surface 206. When attached to surface 206 flap 202 further secures extending portion 201 in the folded position. An identical flap (not shown) is located on the side opposite flap 202. This other flap attaches to a surface opposite surface 206 in the same manner that flap 202 attaches to surface 206. In an alternative embodiment, the hook and loop fasteners of extending portion 201 and flap 202 may be replaced by any other type of fastener, including but not limited to snaps, magnets, buckles, ties, or latches.

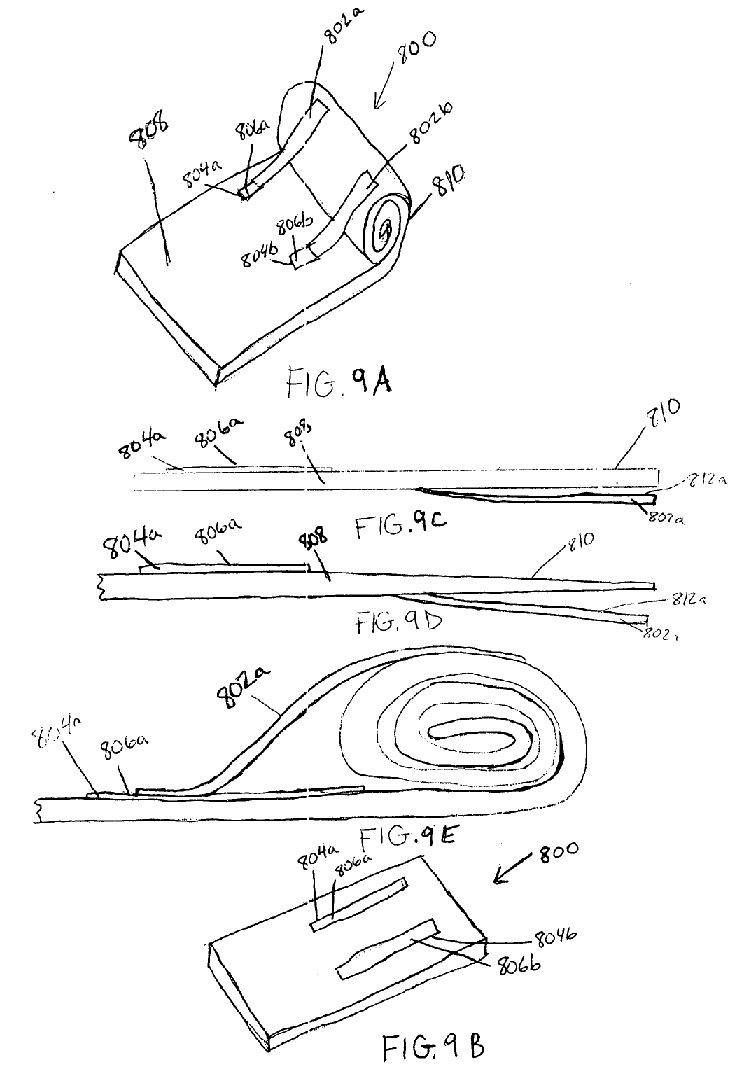

FIG. 9A illustrates an isometric view of a further embodiment of the configurable pet pad 800. In this embodiment, the main portion 808 includes a rollable portion 810 that forms a pillow. As shown in FIG. 9A, rollable portion 810 may be rolled up and secured by hook and loop fasteners of flaps 802a and 802b and strips 804a and 804b. FIG. 9C provides a side view of a cutaway portion of main portion 808 with strip 804a and flap 802a shown in the unattached position. FIG. 9B provides an isometric view of main portion 808 in an unrolled position. Surfaces 806a and 806b of strips 804a and 804b are covered by either hook or loop fasteners, e.g. VELCRO. When surfaces 806a and 806b are covered by hook fasteners, surfaces 812a and 812b of flaps 802a and 802b are covered by loop fasteners. In the rolled up position, flaps 802a and 802b may be attached to strips 804a and 804b by their hook or loop fasteners in order to secure main portion 808 in the rolled up position. Since strips 804a and 804b and flaps 802a and 802b are long, the amount of main portion 808 to be rolled up is adjustable. This characteristic of pad 800 allows it to be more customized for each vehicle in which it is used, since pad 800 may be adjusted to meet an exact dimension of the vehicle. In an alternative embodiment (not shown), strips and flaps may be provided at both ends of main portion 808 so that the pet may have two pillows formed by the foldable portions. In a further embodiment shown in FIG. 9D, rollable portion 810 of main portion 808 is tapered in order to facilitate rolling. The tapering may be incorporated into the embodiment in which both ends of main portion 808 are rolled.

According to various other embodiments exemplified by pet pad 800 of FIGS. 9A-9E, the main portion 808 may include a bottom surface (not shown) made from a different material than the top surface. The entirety of main portion 808 may simply be turned upside-down (e.g., when it becomes colder or hotter in the environment in which pet pad 800 is being used) such that the top becomes the bottom and the bottom becomes the top. Thus, main portion 808 may be turned upside-down to expose a new material to a pet may eliminate the need for a pet owner to buy and/or store multiple pet pads 808 (e.g., for use during different months of the year or for use by different pets). Moreover, it is contemplated that, according to various embodiments, the cooling or heating function of main portion 808 described may only be used when a particular one of the two surfaces is exposed (e.g., when the warmer surface made of fleece, imitation sheep skin, suede material, or similar material is on the top).

Although the invention has been described and illustrated in the foregoing illustrative embodiments, it is understood that the present disclosure has been made only by way of example, and that numerous changes in the details of implementation of the invention can be made without departing from the spirit and scope of the invention. For example, it will be understood that features in one embodiment may be combined with features in other embodiments.

Moreover, it will be understood that, although the invention is described with particular attention to configurable heated pads for use with pets, the invention is not limited in this manner. For example, heated pads may also be used with young children or infants, e.g., in a crib. Moreover, the concepts described herein can be extended, for example, to couches or padding, whether portable or otherwise. Additionally, the configurable concept of the pads disclosed may also be used for pads that do not include any temperature control.

Other embodiments, extensions, and modifications of the ideas presented above are comprehended and should be within the reach of one versed in the art upon reviewing the present disclosure. For example, timer circuitry may also be used in connection with some or all of the embodiments described above. In this case, the timer circuitry may, for example, automatically deactivate (e.g., open) a circuit (regardless of the other conditions) during certain times of the day. According to various other embodiments, timer circuitry may also be used to automatically activate the circuit, regardless of the other conditions (e.g., to attract a pet by the resulting heating or cooling). Accordingly, the scope of the present invention in its various aspects should not be limited by the examples presented above. The individual aspects of the present invention and the entirety of the invention should be regarded so as to allow for such design modifications and future developments within the scope of the present disclosure.

What is claimed is:

1. A pet pad, comprising:
a main portion; and
a plurality of extending portions coupled to the main portion, wherein the extending portions have a contracted position in which at least one of the extending portions overlaps with the main portion and a extended position in which at least one of the extending portions increases a surface area of the pet pad.

2. The pet pad of claim 1, wherein the extending portions are adjustable from the extended position to the contracted position in order to fit inside a cargo space of a vehicle with a smaller surface area than the surface area of the pet pad in the extended position.

3. The pet pad of claim 1, further comprising a cover.

4. The pet pad of claim 3, wherein the cover comprises a nonslip surface.

5. The pet pad of claim 1, wherein an extending portion comprises a fastener and the main portion has a fastener that attaches to the fastener of the extending portion.

6. A pet pad, comprising:
a main portion;
a first extending portion coupled to the main portion such that the first extending portion can be folded on top of the main portion; and
a second extending portion coupled to the main portion such that the second extending portion can be folded on top of the main portion.

7. The pet pad of claim 6, wherein the first and second extending portions can be folded on top of the main portion simultaneously without overlapping.

8. The pet pad of claim 6, wherein one of the main portion, the first extending portion, and the second extending portion comprises a nonslip surface.

9. The pet pad of claim 6, further comprising a cover.

10. The pet pad of claim 9, wherein the cover comprises a fastener, which holds one of the first extending portion and second extending portion on top of the main portion.

11. The pet pad of claim 9, wherein the cover comprises a nonslip surface.

12. The pet pad of claim 6, wherein the first extending portion has a fastener that attaches to a fastener of the second extending portion.

13. The pet pad of claim 6, further comprising:
first and second flaps coupled to the main portion, wherein the first flap has a fastener that attaches to a fastener of the first extending portion and the second flap has a fastener that attaches to a fastener of the second extending portion.

14. The pet pad of claim 6, further comprising:
a third extending portion coupled to the main portion such that the third extending portion can be folded on top of the main portion.

15. The pet pad of claim 14, wherein the third extending portion has a first fastener that attaches to a fastener of the first extending portion and a second fastener that attaches to a fastener of the second extending portion.

16. The pet pad of claim 15, further comprising:
first and second flaps coupled to the main portion, wherein the first flap has a fastener that attaches to a second fastener of the first extending portion and the second flap has a fastener that attaches to a second fastener of the second extending portion.

17. The pet pad of claim 14, wherein the first, second, and third extending portions can be folded on top of the main portion simultaneously without overlapping.

18. The pet pad of claim 14, wherein the first, second, and third extending portions form a uniform wall when they are simultaneously folded on top of the main portion.

19. A pet pad, comprising:
a primary seating surface;
an extending portion coupled to and folded on top of the primary seating surface, wherein the extending portion may be unfolded to expand the surface area of the pet pad; and
a heating and/or cooling device coupled to the primary seating surface.

20. The pet pad of claim 19, further comprising:
an electrical connection coupled to the heating and/or cooling device, wherein the electrical connection allows the heating and/or cooling device to function both on a standard 120 V AC power source and a 12 V DC power source.

21. The pet pad of claim 20, further comprising:
a battery pack that is charged while the heating and/or cooling device is operating on one of the 120 V AC and 12 V DC power source is connected to the heating and/or cooling device.
